(19) United States
(12) Patent Application Publication
(10) Pub. No.: US 2014/0001242 A1
(43) Pub. Date: Jan. 2, 2014

(54) WELDING SYSTEM

(71) Applicant: Robert Bosch GmbH, (US)

(72) Inventor: Reinhard Scholz, Erbach (DE)

(73) Assignee: Robert Bosch GmbH, Stuttgart (DE)

(21) Appl. No.: 13/720,433

(22) Filed: Dec. 19, 2012

(30) Foreign Application Priority Data
Dec. 31, 2011 (DE) 10 2011 122 690.0

(51) Int. Cl. B23K 37/00

(52) U.S. Cl. CPC B23K 37/00
USPC 228/57

(57) ABSTRACT

A welding system has a baseplate and a plurality of welding components which are arranged on the baseplate.

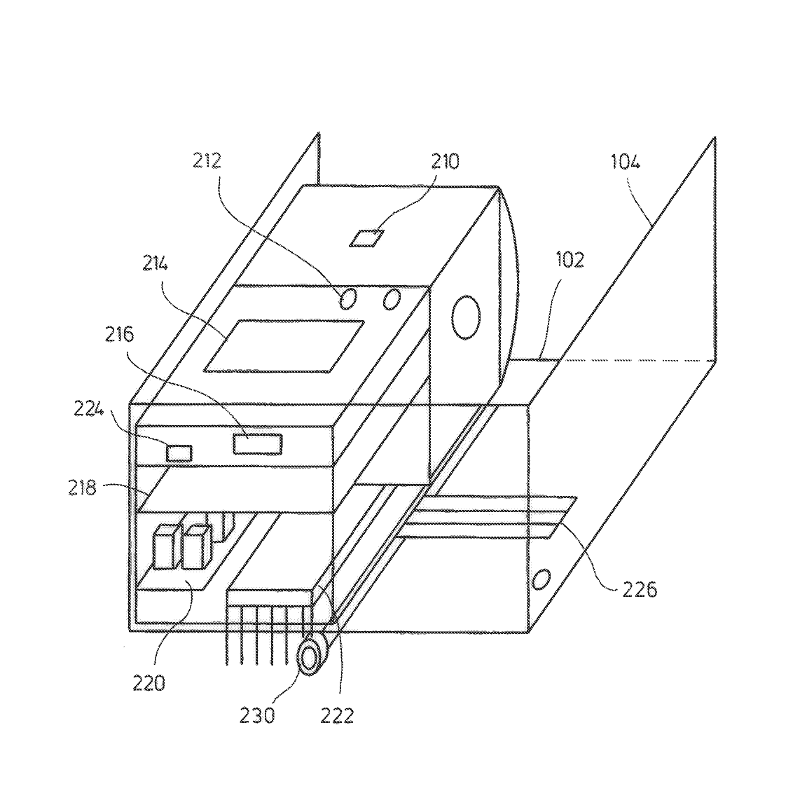

This application claims priority under 35 U.S.C. §119 to patent application no. DE 10 2011 122 690.0, filed on Dec. 31, 2011 in Germany, the disclosure of which is incorporated herein by reference in its entirety.

### BACKGROUND

The present disclosure relates to a welding system which can be used for robot applications, for example.

Welding systems have a plurality of components which are compiled on a customer-specific basis.

It is the object of the present disclosure to provide an improved welding system.

This object is achieved by a welding system according to the description below.

### SUMMARY

The core of the disclosure is a modular arrangement of the welding system components of the welding system, with the result that what is known as a welding cabinet is not required. An essential part of the disclosure is a baseplate on which the welding system components can be mounted. Additional cover means can be added to protect the welding system components mounted on the baseplate. Such a welding system increases the flexibility for the customer and reduces costs for the manufacturer.

The welding system can be used generally in welding engineering, for example for resistance welding.

The present disclosure provides a welding system having the following features: a baseplate; and a plurality of welding components which are arranged on the baseplate.

For a robot application, for example, the welding system can be mounted on or by a robot or can be used in conjunction with a pair of tongs or a water/compressed air installation. The baseplate may be shaped in order to hold the plurality of welding components. In this case, individual welding components from the plurality of welding components may be arranged so as to be stacked above one another. Apart from the actual welding device, for example a pair of welding pliers, the plurality of welding components may comprise all components which are required for a welding system.

By way of example, the plurality of welding components may comprise a converter and/or a network connection and/or a mains connection and/or an operator control module and/or a cooler and/or a welding controller and/or a main switch. For the welding components, it is possible to resort to components which are usually already used in welding engineering.

The baseplate may be in the form of a cast baseplate or in the form of an extruded profile. The baseplate may be in the form of an ARO cast. The casting material used may be aluminum or bronze, for example.

The welding system may comprise a housing for holding the plurality of welding components. The plurality of welding components can be protected and held by the housing.

In this case, the baseplate may be part of the housing. In this way, the welding system can be constructed very compactly.

The housing may have a base, a circumferential wall and a lid. The housing may be configured to be impermeable to spray from all sides. The base may be embodied by the baseplate. The base and the circumferential wall may be integrally formed. By way of example, the base and the circumferential wall may be embodied as a casting, for example as a well-shaped or box-shaped casting. The housing may be configured such that it affords complete protection against contact and protects the plurality of welding components against dust in a harmful quantity.

In this case, the lid may be made of plastic. A lid made of plastic can be matched inexpensively to customer-specific requirements. By way of example, the housing may be embodied by a three-sided cover with a plastic cap. The plastic cap may incorporate an operator control element or contain a cutout for an operator control element.

The lid may have a cutout for a user interface of an operator control module and/or a cutout for a main switch. Edges of the cutout may be sealed with suitable seals.

An interior of the housing may be divided into a first region for the plurality of welding components and a second region, arranged next to the first region, for at least one further welding component from a selection of a plurality of possible further welding components. The welding system may have a connection device for connecting at least one welding component from the plurality of welding components to the at least one further welding component. The at least one further welding component may be an optional welding component. By way of example, the further welding component used may be a component of a drive system, a customer-specific module or a power supply unit. The connecting device may be embodied as a heel rail.

The welding system may have a fastening for attaching the welding system to a robot installation. The fastening may be arranged on an outer side of a housing of the welding system or on the baseplate. By way of example, the fastening may be in the form of an L-profile. The fastening can be used to set up the welding system on a robot cabinet, for example.

### BRIEF DESCRIPTION OF THE DRAWINGS

The disclosure is explained in more detail below by way of example with reference to the enclosed drawing, in which:

The FIGURE shows illustrations of a welding system based on an exemplary embodiment of the disclosure.

Identical or similar elements may be provided with identical or similar reference symbols in the figures which follow. In addition, the figures of the drawings, the description thereof and the claims contain numerous features in combination. In this case, it is clear to a person skilled in the art that these features are also considered individually or that they can be combined into further combinations which are not described explicitly in this case.

### DETAILED DESCRIPTION

The FIGURE shows a schematic illustration of a welding system based on an exemplary embodiment of the disclosure. The welding system is based on a cabinetless configuration. The welding system has a baseplate 102. The baseplate 102 is part of a housing, of which, besides the baseplate 102, a three-sided wall 104 is shown. A space enclosed by the housing contains a plurality of welding components. The plurality of welding components may be arranged in a plurality of planes on the baseplate 102. To this end, suitable mounts may be arranged on the baseplate 102.

The welding components shown in the FIGURE are a main switch 210, a mains connection 212, an operator control element 214, for example in the form of programming or a touchscreen, a welding controller 216, a printed circuit board 218, a converter 220, a cooler 222, a network connection 224 and a connecting rail 226.

The main switch 210 and the operator control element 214 are arranged on a side of the welding system that is remote from the baseplate 102. The main switch 210 and the operator control element 214 may be arranged such that they can be operated by a user of the welding system. The main switch 210 can be used to switch off or switch on the welding system. The main switch 210 may be embodied with or without an FI function on a customer-specific basis. The operator control element 214 can be used to customize settings for the welding system and to programme in functions of the welding system.

The network connection 224 may be embodied as an Ethernet connection. The network connection 224 can be used to control the welding controller 216. In addition or as an alternative, the network connection 224 can be used to control external components of the welding controller 216.

The mains connection 212 can be used to supply the welding system with electric power. The converter 220 may comprise a suitable electronics unit and, by way of example, capacitors. The cooler 222 can be used to cool the converter 220 and, in addition or as an alternative, to cool other welding components. The cooler 222 may be in the form of an air cooler or alternatively a water cooler. If the housing 102, 104 is in the form of an extruded profile, two different embodiments of the extruded profile can be used, depending on the embodiment of the cooler 222.

The connecting rail 226 may be arranged on a surface of the baseplate 102. The connecting rail 226 leads into a customer-specific region of the housing. The customer-specific region can be used to hold customer-specific components or modules, which can be coupled to the other welding components. The connecting rail 226 may be as a heel rail for a drive system, for example Indradrive, and customer-specific modules and, by way of example, a 240V power supply unit. In the illustration shown in the FIGURE, the customer-specific region is arranged on one half of the baseplate 102, with the result that the customer-specific modules can be arranged next to the other welding components 210, 212, 214, 216, 218, 220, 222, 224, 226 at the side. As an alternative, the customer-specific region may be arranged not at the side but rather at the top or bottom. Hence, the customer-specific modules may also be arranged between the baseplate and the other welding components 210, 212, 214, 216, 218, 220, 222, 224, 226, or the other welding components 210, 212, 214, 216, 218, 220, 222, 224, 226 may be arranged between the baseplate and the customer-specific modules.

The housing may have a bracket, for example a U-profile, arranged on it as adaptation for a hanging installation or a robot installation. In the case of an adaptation for a hanging installation, it is possible to implement mounting of the HIP components, that is to say water and compressed air, and a tubular frame as protection with a suspension option. In the case of an adaptation for a robot installation, an L-profile can be attached to the housing 102, 104 in order to be able to set up the housing 102, 104 on a robot cabinet.

The welding components 210, 212, 214, 216, 218, 220, 222, 224, 226 may be a standard welding system which is fitted in the housing 102, 104. A plastic cap can be placed over it, that is to say over the wall 104, for example, in order to implement a desired type of protection, in this case IP54. A PG gland 230 can be routed through the housing, for example through the wall 104. The PG gland 230 may be a sealed housing bushing for cables. A customer-specific sheet can be used for connections in order to implement alternative connectors or a further PG gland.

The exemplary embodiments shown are chosen merely by way of example and can be combined with one another.

What is claimed is:

1. A welding system comprising:
a baseplate; and
a plurality of welding components which are arranged on the baseplate.

2. The welding system according to claim 1, wherein the plurality of welding components comprises at least one of a converter, a network connection, a mains connection, an operator control module, a cooler, a welding controller, and a main switch.

3. The welding system according to claim 1, wherein the baseplate is one of a cast baseplate and an extruded profile.

4. The welding system according to claim 1, further comprising:
a housing configured to hold the plurality of welding components.

5. The welding system according to claim 4, wherein the baseplate is part of the housing.

6. The welding system according to claim 4, wherein:
the housing has a cover including a base, a circumferential wall, and a lid; and
the housing is configured to be impermeable to spray from all sides.

7. The welding system according to claim 6, wherein the lid is made of plastic.

8. The welding system according to claim 6, wherein the cover has at least one of a cutout for a user interface of an operator control module and a cutout for a main switch.

9. The welding system according to claim 6, further comprising:
an interior of the housing, the interior divided into a first region for the plurality of welding components and a second region, arranged next to the first region, for at least one further welding component from a selection of a plurality of possible further welding components; and
a connecting device configured to connect at least one of the plurality of welding components to the at least one further welding component.

10. The welding system according to claim 1, further comprising a fastening configured to attach the welding system to a robot installation.
